(19) United States
(12) Patent Application Publication
(10) Pub. No.: US 2008/0154567 A1
(43) Pub. Date: Jun. 26, 2008

(54) VIRAL GENOTYPING METHOD

(75) Inventors: Ping Qiu, Edison, NJ (US); Jonathan Richard Greene, South Orange, NJ (US); Wei Ding, Scotch Plains, NJ (US); Qing Zhang, Short Hills, NJ (US)

Correspondence Address: SCHERING-PLOUGH CORPORATION;PATENT DEPARTMENT (K-6-1, 1990), 2000 GALLOPING HILL ROAD, KENILWORTH, NJ, 07033-0530, US

(73) Assignee: Schering Corporation

(21) Appl. No.: 11/959,536

(22) Filed: Dec. 19, 2007

Related U.S. Application Data
(60) Provisional application No. 60/876,809, filed on Dec. 22, 2006.

(51) Int. Cl. G06G 7/58

(52) U.S. Cl. 703/11

(57) ABSTRACT

The present invention relates to a method for developing algorithms that are capable of discriminating among different genotypes and subtypes of a virus of interest. The method includes aligning a set of viral nucleotide sequences having known genotypes and analyzing the aligned sequences to identify nucleotide positions at which the nucleotide is conserved within genotypes, but diversified across the different known genotypes. These positions, referred to herein as genotyping positions, are employed as predictive variables to compile a variable input table for analysis by a statistical classification algorithm. The variable input table also includes the nucleotide present at each genotyping position as a value and the genotype for each of the aligned sequences as a response variable. The algorithm analyzes the sequences of nucleotides at the genotyping positions across the aligned viral sequences, and uses the results of this analysis to specify parameters for each genotyping position that when combined across the genotyping positions will discriminate among the genotypes represented in the input sequences. The algorithm generated by this method is useful in a method of predicting the genotype of a viral isolate of interest, such as a virus present in a biological sample obtained from an individual.

The present application claims the benefit of U.S. Provisional Patent Application No. 60/876,809, filed Dec. 22, 2006, which is incorporated by reference.

### FIELD OF THE INVENTION

The present invention relates generally to viral genotyping methods. More specifically, the invention relates to the use of viral genomic sequences and statistical classification algorithms to predict the genotype of a virus in a biological sample.

### BACKGROUND OF THE INVENTION

In the last two decades, a number of DNA and RNA viruses have emerged to become increasing threats to human health, including Human Papillomavirus (HPV), Hepatitis B virus (HBV), Hepatitis C virus (HCV) and Humn immunodeficiency virus (HIV). Research scientists and clinicians are searching for epidemiological, pathological and other characteristics of viral pathogens that may permit more effective management of chronically infected individuals.

For example, the genotype of HCV appears to be an important determinant of the severity and aggressiveness of the viral infection, as well as patient response to antiviral therapy (Zein, N N, Clin. Microbiol. Rev. 13:223-35 (2000)). HCV has a positive-sense, single-stranded RNA genome of about 9.6 kb containing one long open reading frame (ORF) with untranslated regions at both ends (Choo et al., Science 244:359-362 (1989)). There is considerable heterogeneity in the genomic sequence among isolates found in different geographic regions. To date, six major HCV genotypes (HCV-1 to HCV-6) have been described, each containing multiple subtypes (e.g., 1a, 1b, etc.), with genotypes 1-3 being the most prevalent types found in the United States, Europe and Japan. The isolates originally designated as genotypes 7 to 11 are now considered subtypes within genotypes 3 (former genotype 10) and 6 (former genotypes 7, 8, 9, and 11) (Tokita et al., J. Gen. Virol. 75:2329-2335 (1995); Sandres-Saune et al., J. Virol. Methods 109:187-193 (2003)). Several studies suggest that infections of type 1, in particular type 1b, may be associated with more severe disease and earlier recurrence (Zein, N. N. et al., Liver Transplant. Surg. 1: 354-357 (1995); Gordon et al., Transplantation 63: 1419-1423 (1997)), and that HCV type 1 infections of high viral load have the lowest response rates to combination therapy with pegylated-interferon alpha and ribavirin, which is currently the standard of care for HCV (Zeuzem, S., Ann. Intern. Med. 140, No. 5:370-381 (2004)).

Similarly, HBV genotype appears to be correlated with disease progression and clinical outcome (Guettouche, T. et al., Antivir. Ther. 10:593-604, (2005)). HBV is the smallest known human DNA virus, with a genomic of about 3200 base pairs. To date, eight HBV genotypes (A-H) have been described, with most of these types containing multiple subtypes (e.g., A1, A2, B1, B2, etc.) (Guettouche, T., supra). In general, HBV genotypes C and D are associated with more severe liver disease, and have a lower response rate to interferon-alpha therapy, than genotypes B and A, respectively (Guettouche, T., supra).

HPV, which is a circular double-stranded DNA virus having about 8000 base pairs, has been classified into more than 100 types, with about 30 of these types being epitheliotrophic for the anogenital mucosa (Somiati-Saad et al., Clinica Chimica Acta 363:197-205 (2006)). A number of these HPV types are classified as low-risk or high-risk for disease severity, with five low-risk types (HPV-6, -11, -42, -43 and -44) associated with genital warts and mild squamous dysplaisia and 14 high-risk types (HPV-16, -18, -31, -33, 35, -39, -45, -51, -52, -54, -56, -58, -59 and -66) associated with higher grade cervical dysplasia and cervical cancer (Somiati-Saad et al., supra). Thus, assays that detect HPV infection need to differentiate between the low-risk and high-risk types to be clinically useful.

The retrovirus HIV, which is responsible for acquired immunodeficiency syndrome (AIDS), is classified into two genotypes: HIV-1 and HIV-2, with HIV-1 being the type found in the major proportion of infected individuals worldwide (Kandathil, A. J., et al., Indian J. Med. Res. 121 (4):333-344 (2005)). Based on phylogenic analysis of the nucleotide sequence of the env gene, HIV type 1 has been classified into three groups: M (Major/Main), N (on-M, Non-O/New) and O (Outlier), with M being the most prevalent group and currently comprised of nine subtypes: A-D, F-H, J and K (Kandathil, A. J., et al., supra). Studies have associated HIV-1 subtypes A and G with longer AIDS-free survival periods, and HIV-1 subtype D with a lower risk of virus transmission from mother to infant compared with HIV-1 subtypes A and D (Kandathil, A. J., et al., supra). HIV-2 has been classified into eight groups, which are designated as A to H, although groups C-H represent only a few unique isolates (Kandathil, A. J., et al., supra). Thus assays that can distinguish among HIV types and subtypes will help understand the molecular epidemiology of HIV and may lead to more targeted therapies for HIV-infected individuals.

The above description of the heterogeneity of some common viruses illustrate the need for genotyping assays that quickly and accurately discriminate among genotypes and subtypes of viral pathogens. Such assays are provided by the present invention.

### SUMMARY OF THE INVENTION

In one embodiment, the present invention provides a method for generating a genotype prediction algorithm for a virus. The method comprises (a) obtaining, for at least one genomic region of the virus, a training set of nucleotide sequences of known genotypes, wherein the training set represents at least two different genotypes of the virus;

(b) aligning each sequence in the training set against a template sequence;

(c) storing the aligned sequences and their genotypes in a relational database, wherein each stored sequence is associated with its genotype;

(d) identifying, for each stored genotype, each position at which a majority of the sequences associated with that genotype have the same nucleotide;

(e) identifying each position that has the same nucleotide in each of the stored sequences;

(f) generating an initial set of genotyping positions for the virus by removing the positions identified in step (e) from the positions identified in step (d);

(g) compiling a variable input matrix which comprises the genotype for each sequence in the training set as a response variable, the genotyping positions from step (f) as predictive variables, and the nucleotide present at each genotyping position in each sequence in the training set as values for the predictive variables; and

(h) applying a statistical classification algorithm to the variable input matrix to generate a predictive algorithm, wherein the algorithm specifies parameters for each genotyping position in the variable input matrix that when combined across the genotyping positions will discriminate among the genotypes represented in the training set; and

(i) validating the accuracy of the predictive algorithm generated in step (h); wherein steps (d) and (e) may be performed sequentially in either order or simultaneously.

In other embodiments, the invention provides a computer readable medium comprising instruction code to cause a computer to execute the steps of the above method, a processor programmed to execute the steps of the above method.

In another embodiment, the invention provides a computer system for predicting the genotype of a virus present in a biological sample. The computer system comprises a relational database for storing sequences of the virus associated with their genotypes, a processor connected to the database, and a computer program, for controlling the processor, wherein the computer program comprises instruction code to perform the steps of the above method.

In yet another embodiment, the invention provides a method of predicting the genotype of a virus present in a biological sample comprising:

assaying the viral nucleic acid in the sample to determine the nucleotide present at each genotyping position identified in accordance with the above method; and

inputting the assay results into a predictive algorithm generated according to the above method; and

recording the genotype predicted by the algorithm.

### BRIEF DESCRIPTION OF THE DRAWINGS

FIG. 1 lists the sequence of GenBank Accession No. D90208 (SEQ ID NO:1), which is used as the template HCV genomic sequence used in one preferred embodiment of the invention.

### DETAILED DESCRIPTION

### I. Definitions

So that the invention may be more readily understood, certain technical and scientific terms are specifically defined below. Unless specifically defined elsewhere in this document, all other technical and scientific terms used herein have the meaning that would be commonly understood by one of ordinary skill in the art to which this invention belongs when used in similar contexts as used herein.

As used herein, including the appended claims, the singular forms of words such as “a,” “an,” and “the,” include their corresponding plural references unless the context clearly dictates otherwise.

“Consists essentially of” and variations such as “consist essentially of” or “consisting essentially of” as used throughout the specification and claims, indicate the inclusion of any recited elements or group of elements, and the optional inclusion of other elements, of similar or different nature than the recited elements, which do not materially change the basic or novel properties of the specified dosage regimen, method, or composition. As a nonlimiting example, a nucleic acid molecule which consists essentially of a recited nucleic acid sequence may also include one or more nucleotides that do not materially affect the properties of the nucleic acid.

“Gene” is a segment of DNA that contains the coding sequence for a protein, and the segment may also include one or more untranslated regions that affect transcription or translation of the coding sequence, such as a promoter region and 5′ and 3′ untranslated regions.

“Genomic region” is a portion of a viral genome; the 5′ and 3′ boundaries of a genomic region are typically defined by reference to a consensus or template nucleotide sequence.

“Genotyping” is a process for determining a genotype of a virus isolate or virus present in a biological sample.

“Genotyping position” is a specific nucleotide position in a viral genomic region at which nucleotide variation occurs among the different genotypes or subtypes of a virus, but is conserved within a single genotype or subtype. The location of a genotyping position in a viral genomic region is typically identified by reference to its location in a consensus or template sequence relative to a designated starting or ending position for the entire genome, or for a genomic region, such as a 5′ boundary or 3′ boundary. The skilled artisan understands that a particular viral isolate may have one or more insertions or deletions in its genomic sequence or a genomic region of interest as compared to the consensus or template sequence; thus, the location of a genotyping position in that viral isolate may not occur at precisely the same position number, relative to the designated start and stop positions, that is assigned to the same genotyping position in the template sequence. The skilled artisan will understand that specifying the location of any genotyping position described herein by reference to a particular position in a template sequence is merely for convenience and that any specifically enumerated nucleotide position literally includes whatever nucleotide position the same genotyping position is actually located at in the genome, or same genomic region, in any viral nucleotide sequence employed in the methods of the present invention. One way to determine the actual position of a genotyping position in a viral isolate of interest is to align the template sequence with the nucleotide sequence for the complete genome or genomic region of the viral isolate of interest.

“Isolated” refers to the purification status of a biological molecule such as RNA, DNA, oligonucleotide, or protein, and in such context means the molecule is substantially free of other biological molecules such as nucleic acids, proteins, lipids, carbohydrates, or other material such as cellular debris and growth media. Generally, the term “isolated” is not intended to refer to a complete absence of such material or to an absence of water, buffers, or salts, unless they are present in amounts that substantially interfere with the methods of the present invention.

“Oligonucleotide” refers to a nucleic acid that is usually between 5 and 100 contiguous bases in length, and most frequently between 10-50, 10-40, 10-30, 10-25, 10-20, 15-50, 15-40, 15-30, 15-25, 15-20, 20-50, 20-40, 20-30 or 20-25 contiguous bases in length.

“Patient” is any organism that is infected with a virus through normal behaviors or by experimental intervention, e.g., infection of an animal model for experimental research purposes. The patient can be a mouse, rat, pig, cow, monkey, gorilla, chimpanzee, ape, gibbon, cat, dog, or human. Preferably the patient is a human.

“Polynucleotide” refers to a single-stranded or double-stranded nucleic acid molecule that is more than 100 contiguous bases in length, which may be comprised of DNA, RNA. A single stranded polynucleotide comprising a gene may represent the coding strand for the gene or its complement. A polynucleotide may represent genomic DNA, mRNA, or cDNA.

“Relational database” is a database that organizes data into tables where each row corresponds to a basic entity or fact and each column represents a property of that entity. For example, a table can represent genomic sequences obtained from multiple isolates of a virus, where each row corresponds to the sequence for a single genotype or subtype, and each sequence has multiple attributes, such as a sequence identifier number, strain of the virus, and source of the viral isolate from which the sequence was obtained.

“Template sequence” refers to a sequence for the genome or genomic region of a virus against which other viral sequences may be aligned, and may be the sequence of a single isolate of the virus or in some contexts may be a consensus sequence derived by aligning genomic sequences from multiple viral isolates.

“Virus type” refers generically to a genotype or subtype.

### II. General

The present invention relates to a method for developing algorithms that are capable of discriminating among different genotypes and subtypes of a virus of interest. The method includes aligning a set of viral nucleotide sequences having known genotypes and analyzing the aligned sequences to identify nucleotide positions at which the nucleotide is conserved within genotypes, but diversified across the different known genotypes. These positions, referred to herein as genotyping positions, are employed as predictive variables to compile a variable input table for analysis by a statistical classification algorithm. The variable input table also includes the nucleotide present at each genotyping position as a value and the genotype for each of the aligned sequences as a response variable. The algorithm analyzes the sequences of nucleotides at the genotyping positions across the aligned viral sequences, and uses the results of this analysis to specify parameters for each genotyping position that when combined across the genotyping positions will discriminate among the genotypes represented in the input sequences. The algorithm generated by this method is useful in a method of predicting the genotype of a viral isolate of interest, such as a virus present in a biological sample obtained from an individual.

The methods of the present invention may be applied to any virus currently known or identified in the future, provided that a sufficient number of genomic sequences, for each genotype to be discriminated, are already known or can be readily determined to use to train the statistical classification algorithm. The number of sequences required to discriminate among types (genotypes or subtypes) of a particular virus will depend on how many types of the virus are known and what degree of sequence diversity exists among the different types. Typically, at least 100 sequences will be included in the training set, and in preferred embodiments, the training set comprises at least 500, 1,000, 2000, 4000, 8000 or 10,000 sequences.

Viruses that may be used in the invention include, for example, human immunodeficiency virus type 1 (HIV-1), human immunodeficiency virus type 2 (HIV-2), hepatitis A virus (HAV), hepatitis B virus (HBV), hepatitis C virus (HCV), severe acute respiratory syndrome virus (SARS), West Nile virus (WNV), human T cell lymphotropic virus type 1 (HTLV-1), human T cell lymphotropic virus type II (HTLV-2), human papilloma virus (KIEV), herpes viruses, Epstein-Barr virus (EBV), and varicella virus. Other DNA and RNA viruses are known in the art. In preferred embodiments, the virus is HIV-1 or HCV, and in most preferred embodiments, the virus is HCV.

The viral nucleotide sequences used in the invention are for at least one genomic region in the virus. Multiple genomic regions from the virus may be employed to identify one or two regions that provide sufficient discriminating information. If multiple genomic regions are used, they may be noncontiguous or contiguous regions that span the length of the genome.

The training set of viral nucleotide sequences may be obtained from pre-existing private or public databases such as Genank, and nucleotide sequences from different databases may be combined for use in constructing the sequence alignment. The database should identify the viral sequences by genotype and preferably by subtype. In a preferred embodiment, the database also identifies the viral sequences by the isolate from which they were determined, thereby allowing exclusion from the training set of redundant sequences that belong to the same isolate.

The training set of sequences of known genotype are aligned against a template sequence using any sequence alignment program that is capable of identifying regions of similarity between two or more nucleotide sequences. A preferred template sequence has complete sequence data for the genomic region(s) of interest. A more preferred template sequence is annotated with the location of one or more genes or other gene expression features of interest to help identify moderately conserved regions that may be a good source of genotyping positions.

The sequences may be aligned to achieve a global alignment or a local alignment. Calculating a global alignment is a form of global optimization that “forces” the alignment to span the entire length of all query sequences. By contrast, local alignments identify regions of similarity within long sequences that may be widely divergent overall. Local alignments may be preferable for generating predictive algorithms for a genomic region that is less than about 750 nucleotides; however, with sufficiently similar sequences, there is no difference between local and global alignments. The viral nucleotide sequences may be aligned using a pairwise sequence alignment method, which finds the best-matching piecewise (local) or global alignments of two query sequences, or may be aligned using a multiple alignment method, which is used to align three or more of the sequences, and preferably all of the sequences in the training set. Examples of commercially available pairwise and multiple alignment algorithms are listed on the following Wikipedia web page (http:/en.wikipedia.org/wiki/Sequence_alignment_software#Multiple_sequence_alignment).

The aligned sequences are stored in a relational database along with their known genotypes and subtypes. Any relational database capable of organizing genotype information and sequence data into relational tables may be used in the present invention. Software packages useful for creating the relational database include Oracle, Microsoft SQL Server, PostgreSQL, MySQL and Sybase.

An initial set of genotyping positions is generated by examining the sequences for each genotype represented in the database to identify genotype conserved positions and virus conserved positions. The genotype-conserved positions are those at which the nucleotide is conserved among the sequences of the same genotype and the virus-conserved positions are those at which the same nucleotide is present in all the sequences, e.g., across all genotypes. The virus-conserved positions are removed from the genotype-conserved sequences to generate the initial set of genotyping positions. A conserved position is one in which the same nucleotide is present in >50% of the sequences in the training set. Preferably, a conserved position has the same nucleotide present in at least 60%, 70%, 75%, 80%, 85%, 90% or 95%.

In some embodiments, it may be evident from the aligned viral nucleotide sequences that one or more of the sequences lack a nucleotide assignment for one or more positions, which is referred to as “missing nucleotide data”. In such cases, a nucleotide assignment is inferred for the missing data position by using the nucleotide that is most frequent for that genotype at that position, or the nucleotide that is most frequent for all genotypes at that position. In a preferred embodiment, this frequency information is obtained from a genotype specific position weight matrix (PWM) or global PWM, both of which are generated as described by Qiu et al., BMC Microbiol. 2:29 (2002). In brief, the PWM is generated by compiling the number of occurrences of each nucleotide base (adenine, thymine, cytosine and guanine) at a given position, converting these counts to frequencies, and calculating an odds score for each position by dividing the frequency of a given base observed at that position by the theoretical frequency expected (e.g., the background frequency of that base, usually averaged over the genome ˜0.25 base), and converting the odds scores to log odds scores.

The initial set of genotyping positions and the nucleotides present in the training set at these positions are used to compile a variable input matrix, in which the genotypes of the training sequences are response variables, the genotyping positions are predictive variables, and the nucleotides present at the genotyping positions in the training sequences are values for the predictive variable. For example, for a hypothetical set of five genotyping positions and hypothetical training set of five HCV nucleotide sequences, the variable input matrix may be represented by the table below.

| | | Genotyping Position | | | | |
|---|---|---|---|---|---|---|
| Sequence | | (Template Position Number) | | | | |
| Identifier | Genotype | 7 | 25 | 37 | 49 | 100 |
| 1 | 1a | C | C | A | T | T |
| 2 | 1b | A | A | G | T | G |
| 3 | 1b | A | A | G | T | T |
| 4 | 2 | C | G | T | G | G |
| 5 | 3 | T | T | T | G | A |

In the above table, which represents a limited data set, it is evident by visual inspection that genotype 1 (combined subtypes 1a and 1b) can be distinguished from non-genotype 1 by determining the identity of the nucleotides present at genotyping positions 25, 37 and 49, genotypes 1a and 1b can be distinguished from each other by determining the identity of the nucleotide present at genotyping position 37, and genotypes 2 and 3 can be distinguished from each other and from genotype 1 by determining the identity of the nucleotide present at genotyping positions 7, 25 and 100.

However, since the training set will typically have many more sequences and genotyping positions, the method of the invention employs a statistical classification algorithm to derive a prediction algorithm from the variable input table. The prediction algorithm specifies parameters for each genotyping position that, when combined across the set of genotyping positions, will discriminate among the genotypes present in the training sequences. A variety of statistical classification algorithms may be used in the present invention, including support vector machine (SVM) algorithms, random forest algorithms, linear classifier algorithms, k-nearest neighbor algorithms, decision tree algorithms, neural network algorithms, and Bayesian network algorithms. The theory and operation of these algorithms, which are well-known in the bioinformatics art, and are generally described in Duda, Pattern Classification, Second Edition, 2001, John Wiley & Sons, Inc. and Hastie et al., The Elements of Statistical Learning, 2001, Springer-Verlag, New York.

Support vector machines (SVMs) are techniques that have been developed for statistical pattern recognition, and have been applied to many pattern recognition areas, including prediction of protein secondary structures (Nguyen, M. N. and Rajapakse, J. C., Two-stage multi-class support vector machines to protein secondary structure prediction, Pac. Symp. Biocomput. 346-357 (2005); protein-protein binding site (Bradford, J. R. and Westhead, D. R. Bioinformatics 21:1487-1494 (2005); Res, I., et al., Bioinformatics 21:2496-2501 (2005); remote protein homologs (Busuttil, S., et al., Genome Inform. Ser. Workshop Genome Inform. 15:191-200 (2004), protein domains (Vlahovicek, K., et al., Nucleic Acids Res. 33:D223-D225 (2005); protein subcellular localization (Hua, S. and Sun, Z., Bioinformatics 17:721-728 (2001); Nair, R and Rost, B., J. Mol. Biol. 348:85-100 (2005) and gene and tissue classification from microarray expression data (Brown, M. P. S. et al., Proc. Natl. Acad. Sci. USA 97:262-267 2000).

SVM is a learning algorithm which from a set of positively and negatively labeled training vectors learns a classifier that can be used to classify new unlabeled test samples. SVM learns the classifier by mapping the input training samples {x1, . . . , xn} into a possibly high-dimensional feature space and seeking a hyperplane in this space which separates the two types of examples with the largest possible margin, i.e. distance to the nearest points. If the training set is not linearly separable, SVM finds a hyperplane, which optimizes a trade-off between good classification and large margin (Cristianini N, Shawe-Taylor J., An Introduction to Support Vector Machines, Cambridge University Press, Cambridge, UK (2000)). In addition to linear versions of SVMs, they have been extended to nonlinear cases via kernels. Linear, polynomial, sigmoid and radial basis kernels may be used in generating a predictive algorithm in accordance with the present invention. A preferred kernel is the radial basis default kernel implemented in package e1071, which is available from the R Foundation for Statistical Computing, whose web site address is http://www.r-project.org/.

Random forest is a classification algorithm that uses an ensemble of classification trees and provides feature importance (Breiman, Learning 45:5-32 (2001)). Its basic idea is as follows. A forest contains many decision trees, each of which is constructed by instances with randomly sampled features. The prediction is by a majority vote of decision trees. Random forest uses both bagging (bootstrap aggregation), a successful approach for combining unstable learners, and random variable selection for tree building. Each tree is unpruned (grown fully), so as to obtain low-bias trees; at the same time, bagging and random variable selection result in low correlation of the individual trees. The algorithm yields an ensemble that can achieve both low bias and low variance (from averaging over a large ensemble of low-bias, high-variance but low correlation trees).

Decision tree algorithms belong to the class of supervised learning algorithms. The aim of a decision tree is to induce a classifier (a tree) from real-world examples, e.g., training sequences. This tree can be used to classify unseen examples which have not been used to derive the decision tree. In general, there are a number of different decision tree algorithms, many of which are described in Duda, supra. Decision tree algorithms often require consideration of feature processing, impurity measure, stopping criterion, and pruning. Specific decision tree algorithms include, but are not limited to classification and regression trees (CART), multivariate decision trees, IDS, and C4.5.

A neural network is a two-stage regression or classification model. A neural network has a layered structure that includes a layer of input units (and the bias) connected by a layer of weights to a layer of output units. For regression, the layer of output units typically includes just one output unit. However, neural networks can handle multiple quantitative responses in a seamless fashion.

In multilayer neural networks, there are input units (input layer), hidden units (hidden layer), and output units (output layer). There is, furthermore, a single bias unit that is connected to each unit other than the input units. The basic approach to the use of neural networks is to start with an untrained network, present a training pattern to the input layer, and to pass signals through the net and determine the output at the output layer. These outputs are then compared to the target values; any difference corresponds to an error. This error or criterion function is some scalar function of the weights and is minimized when the network outputs match the desired outputs. Thus, the weights are adjusted to reduce this measure of error. For regression, this error can be sum-of-squared errors. For classification, this error can be either squared error or cross-entropy (deviation).

Three commonly used training protocols are stochastic, batch, and on-line. In stochastic training, patterns are chosen randomly from the training set and the network weights are updated for each pattern presentation. Multilayer nonlinear networks trained by gradient descent methods such as stochastic back-propagation perform a maximum-likelihood estimation of the weight values in the model defined by the network topology. In batch training, all patterns are presented to the network before learning takes place. Typically, in batch training, several passes are made through the training data. In online training, each pattern is presented once and only once to the net.

Bayesian networks (BN) are powerful tools for knowledge representation and inference under conditions of uncertainty. A Bayesian network B=[N, A, Θ] is a directed acyclic graph (DAG) where each node nεN represents a domain variable, and each edge aεA between nodes represents a probabilistic dependency, quantified using a conditional probability distribution θᵢεΘ for each node nᵢ. A Bayesian network (BN) can be used to compute the conditional probability of one node, given values assigned to the other nodes; hence, a BN can be used as a classifier that gives the posterior probability distribution of the node class given the values of other attributes.

Once the predictive algorithm is generated, its performance is validated to evaluate its generalization power and to estimate its prediction capabilities for unknown samples. Validation may be performed using any standard validation technique used for statistical classification algorithms, and will typically include cross-validation, i.e., testing the prediction accuracy on sequences in the training set, and prospective validation.

A simple validation approach is to apply the predictive algorithm to a testing set of sequences of known genotypes, which are hidden to the algorithm. The accuracy of the genotype assignment made by the algorithm is checked for each testing sequence.

In another approach, a decision tree may be used to validate the predictive algorithm. In this approach, the nucleotide values for a select combination of genotyping positions across a training set is standardized to have mean zero and unit variance. The members of the training set are randomly divided into a training subset and a testing subset. The training subset contains a majority of the sequences associated with each genotype in the training set. For example, in one embodiment, two thirds of the members of the training set for each genotype are placed in the training set and one third of the members of the training set are placed in the testing subset. The nucleotide values for a select combination of genotyping positions in the testing subset is used to construct the decision tree. Then, the ability for the decision tree to correctly classify members in the testing subset is determined.

In some embodiments, this decision tree computation is performed several times for the same combination of genotyping positions until an end condition is reached. In each iteration, the members of the training set are randomly assigned to the training subset and the testing subset. Then, the quality of the combination of genotyping positions is taken as the average classification error rate over all iterations of the decision tree computation. The end condition may be when: a preset number of repetitions have been performed, e.g., the estimated number of times required for each of the training sequences to have been randomly assigned to both the training and testing subsets; the average classification error rate equals a preset value and the operator chooses to stop, e.g., due to computing time constraints.

One of the most common cross-validation techniques is a 10 fold cross validation analysis in which the predictive algorithm is built with 90% of the training set. The other 10% of the original training set is then used as a test set for the algorithm. The process is repeated 10 times with 10% of the original training sequences being left out as a test set each time.

In a preferred embodiment, the accuracy of the predictive algorithm is assessed by measuring its sensitivity, specificity and overall accuracy. These measures are defined by

$$sensitivity = \frac{TP}{TP + FN}$$

$$specificity = \frac{TN}{TN + FP}$$

$$overall accuracy = \frac{TP + TN}{TP + TN + FP + FN}$$

where TP, FP, TN and FN refer to the number of true positives, false positives, true negatives and false negatives proteins, respectively.

Once the predictive algorithm has achieved satisfactory accuracy and robustness with viral sequences having known genotypes, it may be applied to predict the genotype of a virus present in a biological sample. The biological sample may be obtained from plasma or serum from a patient believed to be infected with the virus. The sample is processed in a manner suitable to determine the identity of the nucleotide present at each genotyping position used in the predictive algorithm.

In preferred embodiments, one or more genomic regions containing the genotyping positions are amplified using any means known in the art. Polymerase Chain Reaction (PCR) is a well-known amplification technique that can be used in the claimed methods. PCR techniques are taught, for example, in Innis et al., eds. PCR Protocols: A Guide to Methods and Amplification (Academic Press, Inc., San Diego, -7-CA, 1990) and are disclosed in U.S. Pat. Nos. 4,683,202 and 4,965,188. PCR amplification requires the use of a polymerase, which can include Thermus aquaticus (Taq) polymerase (U.S. Pat. Nos. 4,889,818 and 5,352,600), Thermococcus litoralis (Vent) polymerase (U.S. Pat. Nos. 5,210,036 and 5,322,785), Pyrococcus furiosus (Pfu) polymerase (U.S. Pat. Nos. 5,545,552 and 5,948,663), Thermus thermophilus (Tth) polymerase (U.S. Pat. No. 5,192,674), and Thermococcus gorgonarius (Tao) polymerase.

Variants of these enzymes may also be employed. Typically, such variants are mutants having improved fidelity or an increased rate of polymerization. Variants also include mixtures of more than one of these enzymes which also have greater fidelity and rates of polymerization. The above polymerases may also be modified to prevent polymerization of nucleic acid products that are a result of non-specific annealing of primer to template. These modifications inactivate the polymerase until it is exposed to a sufficiently high temperature, such as polymerases modified by antibody binding (see U.S. Pat. Nos. 5,587,287 and 5,338,671).

Viral nucleic acids can also be amplified by reverse transcription PCR (RT-PCR), which is described, inter alia, in U.S. Pat. Nos. 5,322,770, 5,310,652, and 5,561,058. RT-PCR is commonly used to amplify viruses having RNA genomes. First, a copy DNA (cDNA) is reverse transcribed from the viral RNA. The cDNA copy of the viral genome can then be amplified using a PCR method. Enzymes that can be used to reverse transcribe viral RNA genomes include Moloney marine leukemia virus (MoMLV) reverse transcriptase (disclosed in U.S. Pat. Nos. 5,017,492 and 5,668,005), Avian Myeloblastosis Virus (AMY) reverse transcriptase, and variants thereof. The variants of these enzymes typically have been mutated for improved fidelity.

Other amplification methods that produce DNA copies of the viral genome can be used in the methods of the invention. These methods include strand displacement amplification (SDA) (see U.S. Pat. No. 5,422,252) and ligase chain reaction (LCR) (see European patents EP-A-320 308 and EP-A-439-8 182). Polymerases used in these methods include Klenow, T7, T4, and E. coli polymerase I.

Yet other amplification methods useful in the present invention include ligase chain reaction (LCR) (Barany et al., Proc. Natl. Acad. Sci. USA 88:189-93 (1991); WO 90/01069), and oligonucleotide ligation assay (OLA) (Landegren et al., Science 241:1077-80 (1988)); transcription-based amplification systems (U.S. Pat. No. 5,130,238; European Patent No. EP 329,822; U.S. Pat. No. 5,169,766; WO 89/06700) and isothermal methods (Walker et al., Proc. Natl. Acad. Sci. USA 89:392-6 (1992)).

It is also possible to amplify viral nucleic acids using methods that produce multiple RNA copies of viral nucleic acids. These amplification reactions include transcription mediated amplification (TMA), disclosed in U.S. Pat. No. 5,399,491. TMA is an amplification reaction in which an RNA viral genome is reverse transcribed to cDNA. The cDNA copy of the viral RNA genome is used as a template to transcribe multiple RNA copies of the cDNA using an RNA polymerase. Suitable RNA polymerases for use in TMA include T7, T3, SP6, Thermus, and baculovirus RNA polymerase.

Oligonucleotide primers are typically used to amplify the viral nucleic acids. The primers anneal to nucleotide sequences within the viral genome and are used to produce an initial copy of the target region of the viral genome. The primers can also anneal to the initial copy of the viral genome or subsequent copies of the target genomic region during later amplification steps.

A primer can anneal to a nucleotide sequence in the viral nucleic acid molecule along its entire length or a primer can anneal to a nucleotide sequence in the viral nucleic acid molecule along only a portion of its length. If only a portion of the primer anneals to a nucleotide sequence in the viral nucleic acid molecule then the portion that does not anneal to a nucleotide sequence in the viral nucleic acid molecule (i.e., non-annealing portion) can contain a recognition site for an RNA polymerase. The non-annealing portion in this example is useful in TMA methods for production of multiple RNA copies of the viral nucleic acids from cDNA. The non-annealing portion of the primer may alternatively contain sequences that encode recognition sites for restriction endonucleases, hybridize to probes on a solid support, or hybridize to linkers. These, and other, non-annealing sequences can be used to isolate and manipulate the amplified viral nucleic acids. Preferably, the non-annealing portion of the primer is at the 5′ region of the primer.

The annealing portion of the primer can be perfectly or substantially complementary to a nucleotide sequence in the viral nucleic acid sequence. If the annealing portion of the primer is perfectly complementary to the viral nucleic acids then each nucleotide in the primer is the exact complement of each nucleotide in the viral nucleotide sequence. If the annealing portion of the primer is substantially complementary to the viral nucleotide sequence then at least one nucleotide in the primer is not the perfect complement of at least one nucleotide in the viral nucleic acid sequence. Preferably, no more than 10% of the nucleotides in the annealing portion of the primer lack complementarily to nucleotides in the viral nucleic acid sequence. Preferably no more than 7%, 5%, 3%, 2%, or 1% of the nucleotides in the primer lack perfect complementarily to a nucleotide of the target nucleotide sequence. Nucleotides in the annealing portion of the primer may not be perfectly complementary to nucleotides in the viral nucleic acid sequence because a nucleotide in the primer is not complementary to a nucleotide in the viral nucleic acids, e.g., a T and a C, because the primer is missing nucleotides opposite nucleotides in the viral nucleic acid sequence, or because the primer contains nucleotides in addition to nucleotides in the viral nucleic acid sequence.

If the amplification method requires the use of two primers, e.g., PCR, the primers must anneal to opposite strands of the viral nucleic acids and be separated by a number of base pairs that is sufficiently close to allow robust formation of an amplification product. Preferably, the primers anneal to opposite strands of the viral nucleic acids separated by no more than 2,000, 1,500, 1,000, 750, 500, 400, 300, 200, 150, or 100 base pairs. More preferably, the primers anneal to opposite strands of the viral nucleic acids separated by no more than 600, 500, 400, 300 or 200 base pairs.

The viral nucleic acids of a single virus can be amplified in the methods. It is also possible to amplify the viral nucleic acids of more than one virus. For example, the viral nucleic acids of 2, 3, or 5 viruses can be amplified in the methods. Preferably, if the viral nucleic acids of more than one virus are amplified, the viral nucleic acids are those of HIV-1 and HCV, to allow evaluation of patients co-infected with HIV and HCV.

When the viral nucleic acids of more than one virus are amplified they can be amplified simultaneously in a single reaction vessel or separately in different reaction vessels. If the viral nucleic acids of more than one virus are amplified separately in different reaction vessels, the viral nucleic acids of different viruses can be amplified at the same time or at different times.

Other methods of amplifying viral nucleic acids are well known in the art. All of these methods can be readily practiced by one of skill in the art.

The identity of the nucleotides at the genotyping positions in the amplified nucleic acids can be determined by any means known in the art. In preferred embodiments, the amplified genomic region is sequenced using conventional methods to determine the identity of the nucleotides at the genotyping positions in that region. In other embodiments, a genotyping position may be assayed using probe mixtures designed to determine whether an A, G, C or T is present at the genotyping position. Each probe in the mixture can comprise a different label that is detected only when the probe hybridizes to the amplified product.

The label can be any molecule which emits a signal. The label can be, for example, fluorescent, enzymatic (e.g. alkaline phosphatase or horseradish peroxidase), radioactive (e.g., 33P, 32P, 35S, or i2sI) chemiluminescent (e.g., acridinium ester, hemicyanine, or rhodamine labels), a chromophore (e.g., rhodamine, flourescein, monobromobimane, pyrene i trisulfonates or Lucifer yellow), or electrochemiluminescent (e.g., tris(2,2′ bipyridine) ruthenium(II)).

Hybridized probes are detected by any means known in the art. Radioactive probes can be detected, for example, on autoradiographic film, phosphorimaging cassettes, or in scintillation counters. Fluorescent probes are detected, for example, by spectroscopy or fluorometry. Enzymatic probes can be detected by providing substrates converted by the enzyme that produce a color or luminescent change (e.g., S-bromo, 4-chloro, 3-indolylphosphate (BCIP)/nitroblue tetrazolium (NBT) can be provided to probes labeled with alkaline phosphatase and 3, 3, 5, 5′-tetramethylbenzidine (TMB) can be provided to detect probes labeled with horseradish peroxidase). Chemiluminescent probes can be detected on autoradiographic film, phosphorimaging cassettes, or a luminometer. Chromophores are detected, for example, by spectroscopy. Electrochemiluminescent probes are detected, for example, using an Origin tricorder (Igen) subsystem that reads electrochemiluminescent signal.

Other methods of assaying the genotyping positions in the amplified viral nucleic acids are well known in the art. All of these methods can be readily practiced by one of skill in the art.

In some embodiments, the amplified viral nucleic acids are quantified. Viral nucleic acids can be quantified absolutely or relatively. If the viral nucleic acids are quantified absolutely the actual quantity of viral nucleic acid present per volume of blood is determined. The units of viral nucleic acids present can be, for example, a nanogram or gram quantity of viral nucleic acids in the volume of blood, e.g., mL blood. The units of viral nucleic acids can also be represented by the number of copies of the viral genomic nucleic acids present in a volume of blood, e.g., copy number of the viral genomic nucleic acids in the volume of blood. Other representations of the absolute quantity of viral nucleic acid per volume of blood are also known.

A nonlimiting example of a method of absolute quantification of viral nucleic acids is performed by comparing the detected level of probe hybridized to amplified nucleic acid in the patient sample to the detected level of probe hybridized to amplified nucleic acid standards containing known quantities of viral nucleic acid. The known standards provide a basis through which the absolute quantity of viral nucleic acid is determined.

The quantity of viral nucleic acids can also be determined relatively. For example, the viral nucleic acids are assigned a fold or relative expression level compared to, for example, an internal standard or a designated sample in the assay.

The steps of amplifying and quantifying or amplifying, detecting, and quantifying can be performed in separate reaction vessels or in a single reaction vessel. If the steps of amplifying and quantifying are performed in the same reaction vessel then the steps may be performed as a real-time amplification assay. A reaction mixture for real time amplification typically includes both the reagents for amplification of a target nucleic acid and a probe that detects the amplification products. Each time an amplification product is produced a probe that emits a signal is detected. Several well-known commercially available kits are sold for use in real time amplification. These kits include the TaqMan (Applied Biosystems), QuantiTect Probe (Qiagen), and MasterAmp (Epicentre) kits.

The steps of amplifying and quantitating can also be performed in a single tube in a target capture followed by transcription mediated amplification (TMA) assay. The target capture followed by TMA assay separates viral nucleic acids from blood components, amplifies the viral nucleic acids, and detects the amplified viral nucleic acids in a single vessel.

Other methods in which amplifying and quantifying can be performed in a single reaction vessel are known and can be practiced by one of ordinary skill in the art.

All publications mentioned herein are incorporated herein by reference for the purpose of describing and disclosing, for example, the algorithms and molecular methodologies that are described in the publications which might be used in connection with the presently described invention. The publications discussed above and throughout the text are provided solely for their disclosure prior to the filing date of the present application. Nothing herein is to be construed as an admission that the inventors are not entitled to antedate such disclosure by virtue of prior invention.

While preferred illustrative embodiments of the present invention are shown and described, one skilled in the art will appreciate that the present invention can be practiced by other than the described embodiments, which are presented for purposes of illustration only and not by way of limitation. Various modifications may be made to the embodiments described herein without departing from the spirit and scope of the present invention. The present invention is limited only by the claims that follow.

### EXAMPLES

The ability of predictive algorithms built in accordance with the present invention to discriminate among viral genotypes was tested using HCV, since the genotype of a HCV infection is an important determinant of the severity and aggressiveness of disease caused by the infection as well as patient response to antiviral therapy. Fast and accurate determination of viral genotype could provide direction in the clinical management of patients with chronic HCV infections.

### Materials and Methods

### Databases and Resources

GenBank Release 149, August 2005, was downloaded from ftp://ncbi.nlm.nih.gov (Benson, D. A, et al. Genbank, Nucleic Acids Res. 34:D16-D20 (2006)). ClustalW (Thompson, J. D. et al., Nucleic Acids Res 22:4673-4680 (1994) was used for multiple sequence alignment. All statistical analysis were carried out with R using packages randomForest (from A. Liaw and M. Wiener) for random forest and e1071 (E. Dimitriadou, K. Hornik, F. Leisch, D. Meyer and A. Weingessel) for SVM. All non-commercial software used in this study was written in PERL 5.0.

### Example 1

### Construction of Sequence Alignment

All HCV related sequences were extracted from GenBank Release 149, August 2005 by using keyword HCV or Hepatitis C. To reduce weighting bias, redundant sequences that belong to same isolate were removed. D90208 was chosen as the organizing template for its fully annotated genome in the GenBank. Other organizing HCV genomes yielded virtually identical consensus sequences and PWM profiles. Due to the extreme genetic heterogeneity of the HCV genome and large number of complete and partial sequences in the public database, a direct genome wide sequence alignment was not feasible. Pairwise alignments were made between D90208 and all HCV sequences with genotype information (a total of 10,014 sequences. Nucleotides at each position were extracted from the alignments. For each position on the HCV genome, the nucleotide frequency in the overall HCV population as well as in each genotype was calculated. A global position weight matrix (PWM) was made as described previously (Qiu et al., supra). Genotype specific PWMs were also made using this approach. Genome wide PWMs compiled in this step as well as genotype specific PWMs were used to impute missing nucleotides in partial HCV sequences used in model training and in the prediction data set.

### Example 2

### Selection of Genotypes and HCV Subregions for Analysis

The most popular genotypes (with at least 40 sequence records in GenBank) were chosen for this study to warrant significant statistical analysis. The genotypes and subtypes used in this study are 1a, 1b, 2a, 2b, 2c, 3a, 3b, 4, 5, and 6. For sequences that belong to rare genotypes (4, 5, 6), genotypes were used instead of subtypes for genotype classification. For example, all subtypes 4a, 4b sequences were classified into genotype 4. The objective of this study was to explore the possibility of using statistical classification algorithms to develop predictive algorithms for genotyping HCV and to provide a direction in choosing HCV regions for genotype classification using a sequencing based approach. Therefore, genomic regions which can be readily sequenced in one sequencing read was preferable (˜500 bp). Since most of the HCV sequences retrieved from GenBank are partial sequences, to balance the sequence coverage of each genotype, a sub-region was selected for each HCV genome region (5′ NCR, CORE, E1 and NS5B) (Table 1). The total sequences which cover each sub-region were divided into two equal subsets randomly. One subset is used for model training and model building while the other subset is used to estimate the generalization power of the model.

TABLE 1
Regions and sub-regions selected for analysis in this study.
The sub-regions were selected to maximize the sequence
record coverage of each genotype and the sizes were
limited to the length of one sequencing read (~500 bp).

| Genome | | | |
|---|---|---|---|
| Region | Range on D90208 | Sub-Region Selected | # of Sequences |
| 5′ NCR | 1-329 | 73-298 | 611 |
| CORE | 330-889 | 330-700 | 498 |
| E1 | 900-1475 | 900-1475 | 947 |
| NS5B | 7587-9413 | 8200-8600 | 1134 |

### Example 3

### Position Selection

### Feature Selection

To maximize the prediction power and minimize the number of genotyping positions required for the prediction model, nucleotide positions in the HCV genome were pre-selected based on their conservation information provided by PWM described above. We required that positions included in model building were conserved within genotypes and diversified across genotypes. Positions which are 80% conserved among same genotype were chosen in the model training. Positions that are conserved across all genotypes were eliminated from model training. The initial list of genotyping positions selected using these criteria are set forth in Table 2 below.

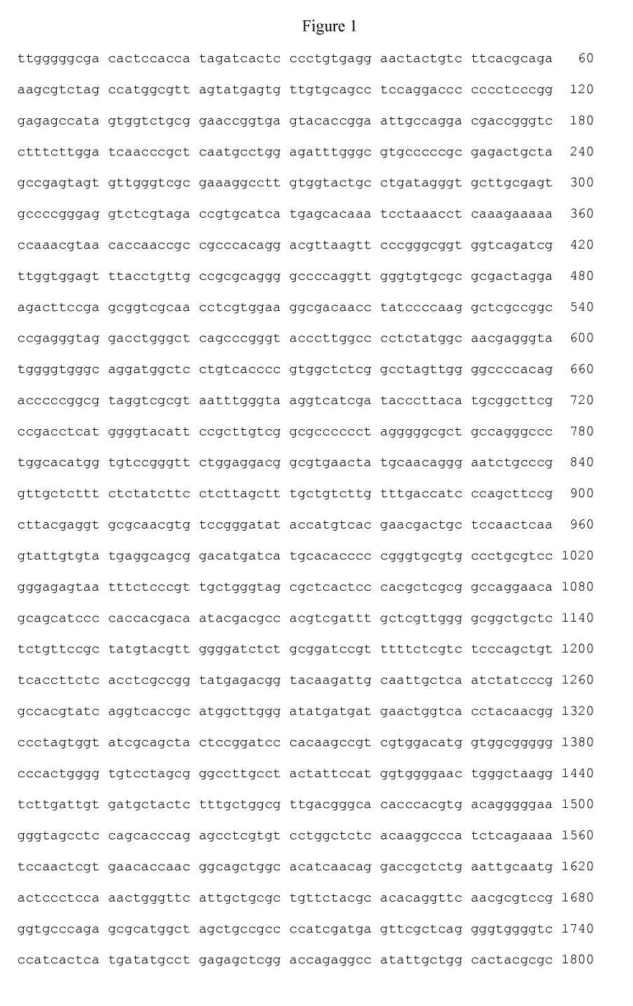

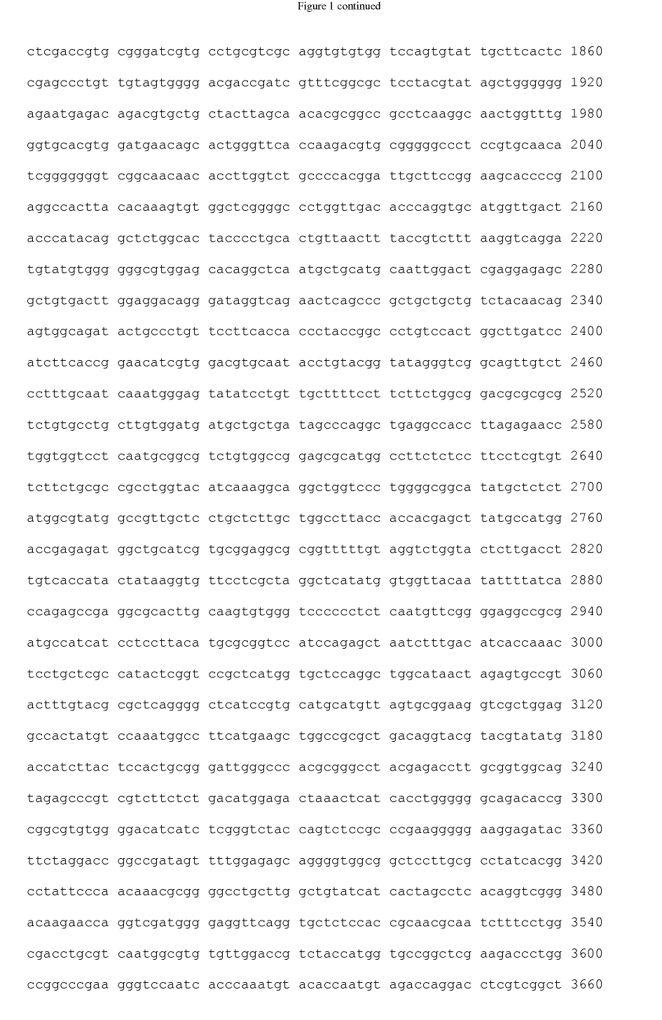

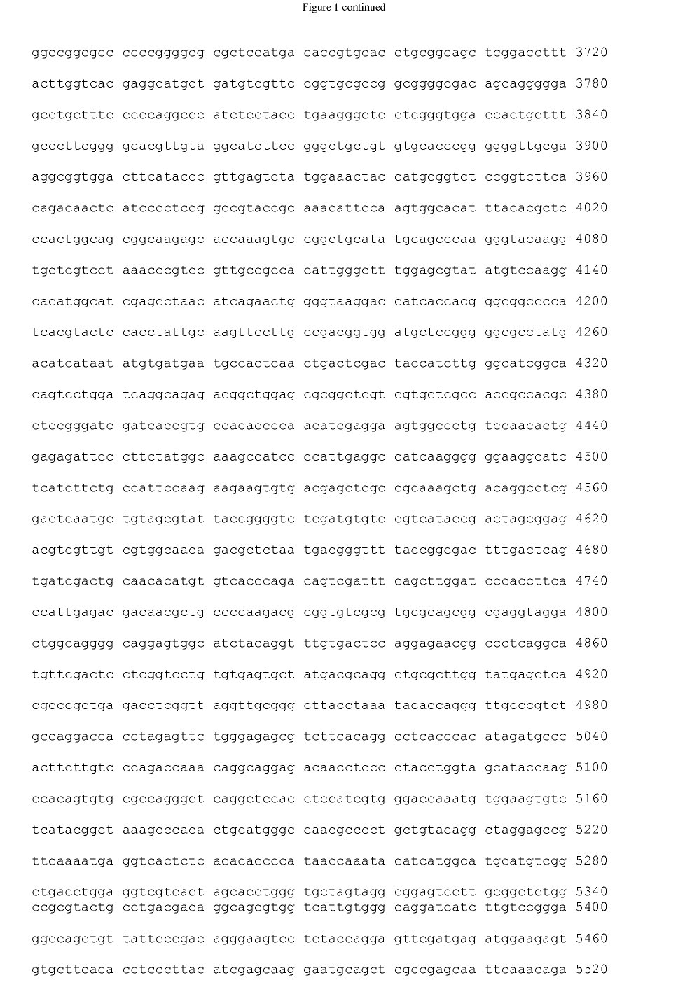

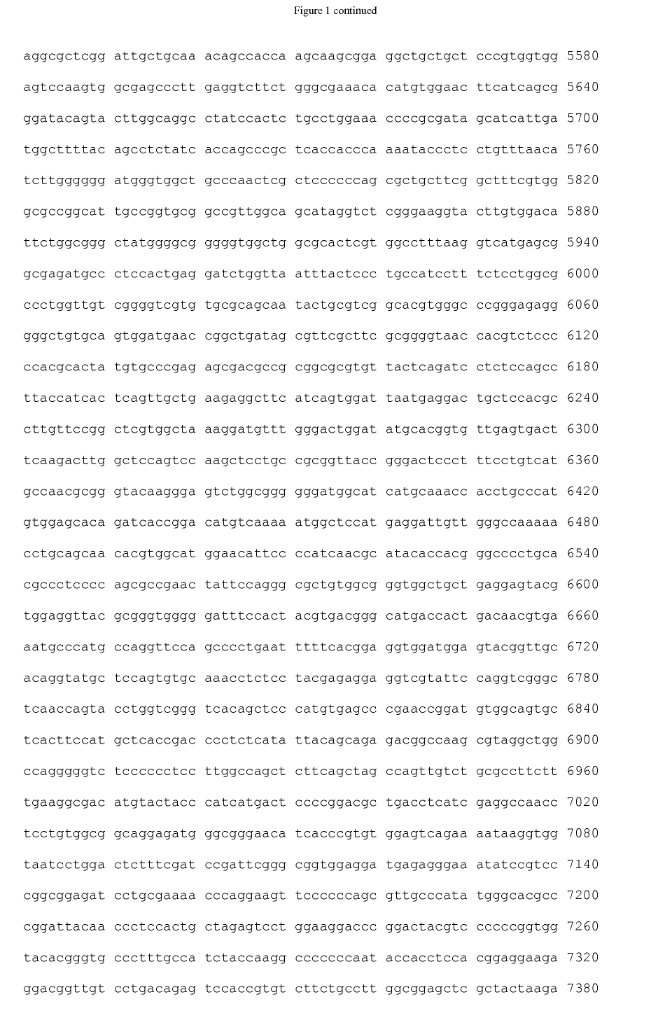

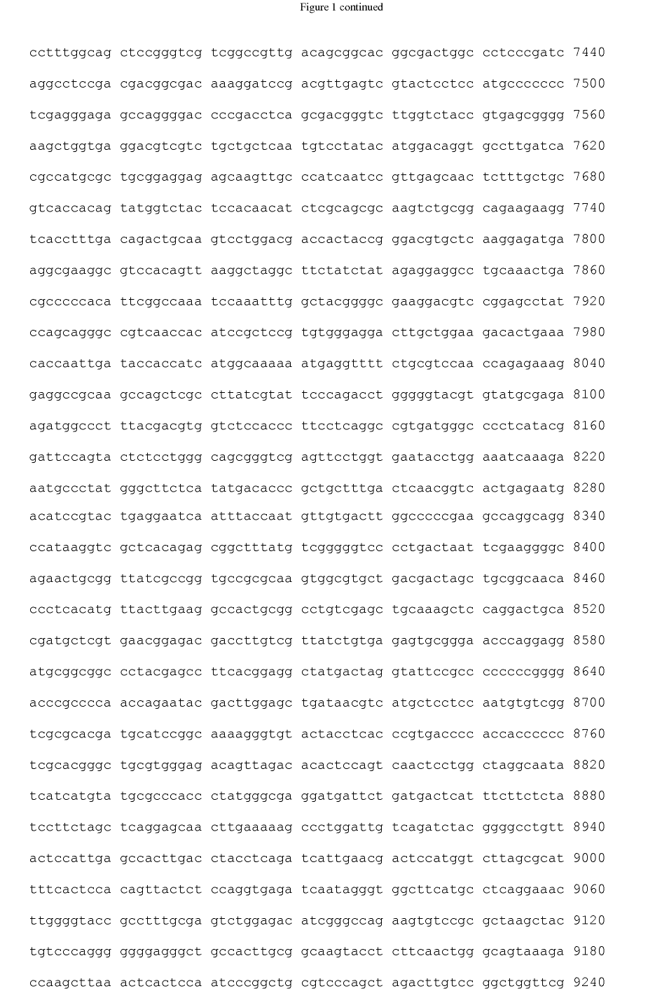

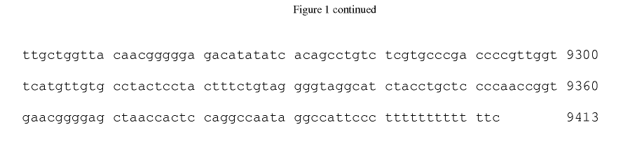

TABLE 2
Nucleotide Positions in HCV Template Sequence (D90208, FIG. 1)

| | | | | | | | | | | | | |
|---|---|---|---|---|---|---|---|---|---|---|---|---|
| NCR | 92 | 95 | 120 | 133 | 231 | 258 | 326 | 328 | | | | |
| CORE | 338 | 339 | 344 | 350 | 357 | 362 | 366 | 368 | 386 | 387 | 388 | 389 |
| | 390 | 401 | 407 | 410 | 425 | 431 | 434 | 435 | 438 | 456 | 458 | 473 |
| | 474 | 475 | 476 | 477 | 479 | 482 | 485 | 488 | 491 | 494 | 500 | 503 |
| | 504 | 506 | 510 | 518 | 521 | 524 | 530 | 532 | 536 | 540 | 541 | 542 |
| | 543 | 544 | 545 | 548 | 549 | 550 | 552 | 553 | 559 | 560 | 561 | 562 |
| | 563 | 566 | 572 | 575 | 581 | 584 | 587 | 589 | 590 | 599 | 600 | 601 |
| | 602 | 611 | 614 | 618 | 620 | 621 | 623 | 629 | 632 | 638 | 646 | 653 |
| | 656 | 658 | 662 | 670 | 672 | 673 | 674 | 677 | 680 | 684 | 689 | 692 |
| E1 | 900 | 901 | 902 | 912 | 917 | 918 | 921 | 922 | 928 | 933 | 934 | 935 |
| | 936 | 941 | 947 | 951 | 954 | 955 | 956 | 957 | 958 | 959 | 960 | 961 |
| | 962 | 966 | 967 | 969 | 970 | 971 | 972 | 974 | 976 | 978 | 979 | 981 |
| | 982 | 984 | 985 | 987 | 989 | 997 | 998 | 999 | 1007 | 1008 | 1009 | |
| | 1010 | 1016 | 1017 | 1018 | 1024 | 1026 | 1029 | 1030 | 1031 | 1034 | 1035 | |
| | 1036 | 1038 | 1047 | 1048 | 1049 | 1050 | 1051 | 1052 | 1053 | 1054 | 1061 | |
| | 1063 | 1068 | 1070 | 1071 | 1072 | 1074 | 1077 | 1081 | 1083 | 1084 | 1086 | |
| | 1088 | 1089 | 1090 | 1091 | 1093 | 1095 | 1096 | 1106 | 1108 | 1110 | 1113 | |
| | 1115 | 1118 | 1119 | 1120 | 1121 | 1122 | 1124 | 1126 | 1127 | 1128 | 1129 | |
| | 1130 | 1131 | 1132 | 1133 | 1136 | 1137 | 1138 | 1139 | 1140 | 1141 | 1149 | |
| | 1151 | 1152 | 1154 | 1158 | 1160 | 1167 | 1175 | 1176 | 1177 | 1180 | 1182 | |
| | 1185 | 1188 | 1189 | 1191 | 1192 | 1196 | 1198 | 1199 | 1200 | 1201 | 1204 | |
| | 1205 | 1207 | 1209 | 1210 | 1217 | 1218 | 1221 | 1226 | 1227 | 1228 | 1230 | |
| | 1231 | 1235 | 1236 | 1237 | 1238 | 1251 | 1253 | 1257 | 1258 | 1259 | 1262 | |
| | 1270 | 1273 | 1278 | 1301 | 1303 | 1305 | 1308 | 1309 | 1314 | 1318 | 1320 | |
| | 1321 | 1335 | 1336 | 1337 | 1339 | 1349 | 1354 | 1355 | 1356 | 1357 | 1364 | |
| | 1365 | 1366 | 1369 | 1374 | 1375 | 1381 | 1385 | 1391 | 1392 | 1394 | 1395 | |
| | 1398 | 1399 | 1402 | 1404 | 1405 | 1415 | 1416 | 1422 | 1423 | 1424 | 1434 | |
| | 1435 | 1436 | 1439 | 1446 | 1447 | 1449 | 1451 | 1452 | 1454 | 1455 | 1461 | |
| | 1462 | 1464 | 1469 | | | | | | | | | |
| NS5B | 8289 | 8290 | 8291 | 8294 | 8295 | 8297 | 8298 | 8299 | 8300 | 8301 | 8306 | |
| | 8309 | 8310 | 8311 | 8312 | 8315 | 8316 | 8317 | 8318 | 8319 | 8321 | 8324 | |
| | 8325 | 8326 | 8327 | 8328 | 8329 | 8330 | 8331 | 8334 | 8337 | 8338 | 8339 | |
| | 8341 | 8343 | 8345 | 8346 | 8347 | 8348 | 8349 | 8351 | 8352 | 8354 | 8357 | |
| | 8358 | 8360 | 8361 | 8363 | 8369 | 8370 | 8371 | 8375 | 8381 | 8382 | 8384 | |
| | 8385 | 8386 | 8390 | 8391 | 8392 | 8393 | 8394 | 8395 | 8396 | 8400 | 8401 | |
| | 8403 | 8404 | 8405 | 8408 | 8412 | 8413 | 8415 | 8417 | 8418 | 8420 | 8426 | |
| | 8432 | 8438 | 8439 | 8440 | 8441 | 8442 | 8450 | 8451 | 8452 | 8453 | 8459 | |
| | 8462 | 8463 | 8468 | 8471 | 8473 | 8474 | 8475 | 8477 | 8483 | 8484 | 8490 | |
| | 8493 | 8494 | 8496 | 8497 | 8498 | 8505 | 8506 | 8513 | 8514 | 8515 | 8516 | |
| | 8520 | 8525 | 8526 | 8528 | 8531 | 8534 | 8537 | 8540 | 8543 | 8544 | 8551 | |
| | 8552 | 8553 | 8555 | 8556 | 8557 | 8558 | 8561 | 8564 | 8565 | 8566 | 8572 | |
| | 8574 | 8575 | 8587 | 8588 | 8589 | 8590 | 8591 | 8593 | 8595 | 8600 | | |

### Example 4

### Data Imputing

Most HCV related sequences retrieved from GenBank are partial sequences and some sequences did not have the full coverage for all signature nucleotide positions selected according to the PWM. To facilitate model building, those missing nucleotide positions for each partial sequence were imputed using the consensus nucleotides derived from the PWM. For the training sequence set, the missing nucleotides were imputed using the genotype specific conserved nucleotides. For the prediction (testing) sequence set, missing nucleotides were imputed using conserved nucleotides across all genotypes. Partial sequences missing more than one third of the selected positions were eliminated from both training and prediction (testing) sets.

### Example 5

### Classification Methods

Various classical and modern statistical methods are available for classification (Khattree, R. and Naik, D., Multivariate Data Reduction and Discrimination with SAS Software, SAS Institute and J Wiley and Sons (2000); Hastie T. et al., The Elements of Statistical Learning Data Mining, Inference, and Prediction Series in Statistics. Springer (2001). To discriminate HCV genotypes using genotyping positions in different HCV genome regions, two modern classification methods were chosen: support vector machine (SVM) and random forest. We generated SVM and random forest models for features (nucleotide positions) selected from four HCV regions (5′ NCR, CORE, E1 and NS5B).

### Example 6

### Cross-Validation

In order to evaluate the generalization power of each of the classification methods and to estimate their prediction capabilities for unknown samples, we used a standard 10-fold cross-validation technique and split the data randomly and repeatedly into training and test sets. The training sets consisted of randomly chosen subsets containing 90% of each class (genotypes); the remaining 10% of the samples from each class were left as test sets. In order to keep computing times reasonable, we reported accuracy and standard deviation estimates over 100 runs. More runs are required if more accurate estimates are desired. We also reported the accuracy of prediction using the prediction (testing) set which are never used for model training.

In order to assess the accuracy of prediction methods measured the sensitivity, specificity and overall accuracy, which are defined by

$$sensitivity = \frac{TP}{TP + FN}$$

$$specificity = \frac{TN}{TN + FP}$$

$$overall accuracy = \frac{TP + TN}{TP + TN + FP + FN}$$

where TP, FP, TN and FN refer to the number of true positives, false positives, true negatives and false negatives proteins, respectively.

The error rates measured during the cross-validation procedure are shown in Table 3 below.

TABLE 3
Average error rates over 100 runs on features from four
HCV genome regions using two different classification algorithms.

| Classification | Region on HCV Genome | | | |
|---|---|---|---|---|
| Method | 5′ NCR | CORE | E1 | NS5B |
| SVM | 21.98 | 19.66 | 1.60 | 0.21 |
| Random Forest | 24.28 | 3.98 | 0.56 | 0.19 |

Error rates for each genotype and subtype were also estimated for both SVM and random forest models, and are shown in Tables 4 and 5 below.

TABLE 4
Average classification error rate (percent) over 100 runs
on different genotypes from 10-fold cross-validation using SVM.

| | Region on HCV Genome | | | |
|---|---|---|---|---|
| Genotype | 5′ NCR | CORE | E1 | NS5B |
| 1a | 1.06 | 0.19 | 0 | 0 |
| 1b | 6.36 | 17.27 | 1.30 | 0.20 |
| 2a | 1.53 | 0 | 0 | 0 |
| 2b | 5.26 | 0 | 0 | 0 |
| 2c | 0 | 0.45 | 0.27 | 0 |
| 3a | 0 | 0.01 | 0 | 0 |
| 3b | 0 | 0.38 | 0 | 0 |
| 4 | 3.11 | 0.39 | 0.24 | 0 |
| 5 | 0.54 | 0 | 0 | 0 |
| 6 | 3.60 | 0 | 0 | 0 |

TABLE 5
Average classification error rate (percent) over 100 runs
on different genotypes from k-fold cross-validation
using random forest.

| | Region on HCV Genome | | | |
|---|---|---|---|---|
| Genotype | 5′ NCR | CORE | E1 | NS5B |
| 1a | 1.93 | 2.14 | 0 | 0 |
| 1b | 5.67 | 0.88 | 0.23 | 0.24 |
| 2a | 2.37 | 0 | 0 | 0 |
| 2b | 0.31 | 0 | 0 | 0 |
| 2c | 4.70 | 0.41 | 0.24 | 0 |
| 3a | 0 | 0.08 | 0 | 0 |
| 3b | 0.67 | 0.22 | 0 | 0 |
| 4 | 5.04 | 0.46 | 0.14 | 0 |
| 5 | 0.52 | 0 | 0 | 0.02 |
| 6 | 4.11 | 0 | 0 | 0 |

### Example 7

### Predictive Algorithms for NS5B and E1 Regions

Genotyping positions from only the NS5B and E1 regions were used to build SVM and random forest models, using essentially the same procedures described above. The predictive power of the resulting algorithms is illustrated in Table 6 below.

TABLE 6
HCV genotype prediction accuracy using an independent data set (result was
reported for models built based on NS5B and E1 only)

| | E1 | | | | | | NS5B | | | | | |
|---|---|---|---|---|---|---|---|---|---|---|---|---|
| | SVM | | | RF | | | SVM | | | RF | | |
| Genotype | SN | SP | AC | SN | SP | AC | SN | SP | AC | SN | SP | AC |
| 1a | 98.9 | 98.3 | 98.8 | 98.4 | 96.7 | 97.4 | 100 | 100 | 100 | 100 | 100 | 100 |
| 1b | 94.8 | 99.7 | 98.8 | 100 | 99.7 | 98.2 | 99.38 | 100 | 99.8 | 99.4 | 99.3 | 99.3 |
| 2a | 100 | 100 | 100 | 100 | 100 | 100 | 100 | 100 | 100 | 75 | 100 | 99.8 |
| 2b | 100 | 100 | 100 | 100 | 100 | 100 | 100 | 100 | 100 | 100 | 100 | 100 |
| 2c | 100 | 100 | 100 | 55.6 | 99.8 | 99 | 100 | 100 | 100 | 93.3 | 100 | 99.8 |
| 3a | 100 | 100 | 100 | 100 | 100 | 100 | 100 | 99.8 | 99.8 | 100 | 99.8 | 99.9 |
| 3b | 100 | 100 | 100 | 100 | 100 | 100 | 100 | 100 | 100 | 100 | 100 | 100 |
| 4 | 100 | 99.8 | 99.8 | 90.4 | 100 | 99 | 100 | 100 | 100 | 100 | 100 | 100 |
| 5 | 100 | 100 | 100 | 100 | 100 | 100 | 96.3 | 100 | 99.8 | 96.3 | 100 | 99.8 |
| 6 | 100 | 100 | 100 | 84.6 | 100 | 98.4 | 100 | 99.8 | 99.8 | 80 | 100 | 99.8 |

### Discussion

Intuitively, a good feature set for classification model building should consist of those members highly correlated within a class but uncorrelated with other classes, as described in Hall, M., Correlation-based feature selection for machine learning, PhD Thesis, Department of Computer Science, Waikato University, Waikato, NZ (1999). Finding the “best” set of features to build a predictive model is a complex combinatorial problem and available methods are generally classified into two categories: filtering methods (those which rank individual features according to some criteria) and more involved wrapper algorithms, which use classification methods directly to evaluate a particular set of features. In this study, we demonstrated that filtering based methods perform reasonably well.

Both SVM and random forest methods demonstrated comparable predictive power in this study. However, the random forest method seems to perform slightly better. Notably, predictive models derived from features selected from the NS5B and E1 regions tended to have more predictive power than those from more conserved regions such as 5′NCR and CORE. This was observed for all genotypes (Tables 4 and 5). Traditionally, the conserved nature of the 5′NCR has made it the preferred target for HCV RNA detection tests, and sequence analysis of amplicons from these tests is the most efficient way to genotype HCV in a clinical laboratory setting since both tests can be completed with the product from a single amplification reaction. However, as indicated in this study, 5′NCR might not be the best choice if more accurate genotyping results are required. This observation is in accordance with a previous study which showed that 5′NCR is too conserved for accurate discrimination of all subtypes (Smith et al, D. B., J. Gen. Virol. 76:1749-1761 1995; Chen, Z. et al., J. Clin. Microbiol. 40:3127-3134 2002; Laperche, S. et al., J. Clin. Microbiol. 43: 733-739 2005).

The average conservation scores for the selected regions in 5′NCR, CORE, E1, NS5B are 96%, 91%, 80% and 80%, respectively, suggesting that a region which can serve to discriminate genotypes tends to be modestly conserved if not the least conserved. Practically, it is considerably easier to develop an assay for a more conserved region such as 5′NCR. However, with the HCV global PWM in hand, it is straightforward to derive the most conserved sequence stretches within NS5B and E1 which facilitates the design of robust nucleotide primers, using the process and associated criteria described in Qiu et al., supra. Genotype or subtype specific primers with higher selectivity for NS5B and E1 can also be derived from PWM if necessary.

As indicated in Table 3 and 4, the error rate for determining subtype 1b is the most significant contributor to the overall error rate, especially in models built on the 5′ NCR. This might be caused by the high degree genome similarity between subtype 1a and 1b. The consensus sequences of 1a and 1b share over 99% similarity in 5′ NCR (73-298); 95% in CORE (330-700); 76% in E1 (900-1475); 83% in NS5B (8200-8600) respectively. In models built using NS5B or E1 signature nucleotides, genotypes 1a and 1b can be easily differentiated with very low error rate suggesting that closely related subtypes can be effectively differentiated by using a more diversified region. The cause of the small remaining error rate is not very clear and one possible source might be mis-classified records from GenBank included in the model building and prediction data set. Manual inspection of some of the mis-predicted records indicated that at least some of them are due to the short available sequence and significant amount of imputing for signature nucleotide positions.

The predictive accuracy of SVM and random forest model for region NS5B and E1 on unseen HCV sequences are also very good (Table 6), with accuracy in the high ninety percent range. Analysis of the mis-classification cases also suggests that sequencing more than one region and predicting with more than one model and taking majority vote will give maximal predictive accuracy (data not shown).

The predictive performance of models built on the variables selected using recursive redundant variable removal approach was also examined. The predictive accuracy of models after backward feature elimination is comparable to that of using signature nucleotides selected using filtering based method (data not shown). Since the goal of this study is to classify HCV genotypes and subtypes, selecting the smallest possible set of features is not the main interest as long as the features can be obtained within one experiment. On the other hand, with all the features being easily obtained within one sequence read, keeping redundant variables might be beneficial when nucleotide reads at certain positions are not easily available due to technical experimental reasons.

In conclusion, we have developed SVM and random forest based methods for discriminating HCV genotypes and subtypes. Models built based on features from NS5B and E1 perform better than those based on features from CORE and 5′ NCR. In addition, a global PWM for the HCV genome can be used to successfully design both global and genotype and subtype specific primers for less conserved regions such as NS5B and E1. To ensure optimal polymerization, the 3′ end and the penultimate position are required to be G or C with frequencies of ≧0.98 and the upstream position, (3′-2), a G or C with a frequency of ≧0.90 or alternatively an A or T with a frequency of ≧0.95. Suggested primers for use in amplifying and sequencing these regions are shown in Table 7 below.

TABLE 7
PCR and sequencing primers for genotyping HCV.

| | |
|---|---|
| Forward | Reverse |

| | | | | | | | |
|---|---|---|---|---|---|---|---|
| | | Con- | | | | Con- | |
| | | servation | | | | servation | |
| Start | End | Score | Sequence | Start | End | Score | Sequence |

| | | | | | | | | |
|---|---|---|---|---|---|---|---|---|
| NS5B | 8050 | 8074 | 93.20% | AGCCAGCTCGCCTTATCGTATTCCC | 8629 | 8605 | 94.5 | GCGGAATACCTGGTCATAGCCTCCG |
| | | | | (SEQ ID NO:2) | | | | (SEQ ID NO:3) |
| | 8083 | 8107 | 89.1 | GGGTTCGTGTGTGCGAGAAGATGGC | 8800 | 8776 | 91.1 | ACTGGAGTGTGTCTAGCTGTCTCCC |
| | | | | (SEQ ID NO:4) | | | | SEQ ID NO:5) |
| | 8082 | 8106 | 89 | GGGGTTCGTGTGTGCGAGAAGATGG | 8634 | 8610 | 89.7 | GGGGGGCGGAATACCTGGTCATAGC |
| | | | | (SEQ ID NO:6) | | | | (SEQ ID NO:7) |
| | 8125 | 8149 | 85.9 | CCACCCTTCCTCAGGCCGTGATGGG | 8633 | 8609 | 89.7 | GGGGGCGGAATACCTGGTCATAGCC |
| | | | | (SEQ ID NO:8) | | | | (SEQ ID NO:9) |
| | 8124 | 8148 | 84.3 | TCCACCCTTCCTCAGGCCGTGATGG | | | | |
| | | | | (SEQ ID NO:10) | | | | |
| E1 | 709 | 733 | 94.1 | CATGCGGCTTCGCCGACCTCATGGG | 1612 | 1588 | 89.3 | TTCAGGGCAGTCCTGTTGATGTGCC |
| | | | | (SEQ ID NO:11) | | | | (SEQ ID NO:12) |
| | 708 | 732 | 94 | ACATGCGGCTTCGCCGACCTCATGG | 1605 | 1581 | 89.3 | CAGTCCTGTTGATGTGCCAGCTGCC |
| | | | | (SEQ ID NO:13) | | | | (SEQ ID NO:14) |
| | 733 | 757 | 93 | GGTACATTCCGCTCGTCGGCGCCCC | 1629 | 1605 | 83.2 | TGAGGCTGTCATTGCAGTTCAGGGC |
| | | | | (SEQ ID NO:15) | | | | (SEQ ID NO:16) |
| | 821 | 845 | 91.2 | TGCAACAGGGAACCTTCCTGGTTGC | | | | |
| | | | | (SEQ ID NO:17) | | | | |

What is claimed is:

1. A method of generating a genotype prediction algorithm for a virus, comprising:
(a) obtaining, for at least one genomic region of the virus, a training set of nucleotide sequences of known genotypes, wherein the training set represents at least two different genotypes of the virus;
(b) aligning each sequence in the training set against a template sequence;
(c) storing the aligned sequences and their genotypes in a relational database, wherein each stored sequence is associated with its genotype;
(d) identifying, for each stored genotype, each position at which a majority of the sequences associated with that genotype have the same nucleotide;
(e) identifying each position that has the same nucleotide in each of the stored sequences;
(f) generating an initial set of genotyping positions for the virus by removing the positions identified in step (e) from the positions identified in step (d);
(g) compiling a variable input matrix which comprises the genotype for each sequence in the training set as a response variable, the genotyping positions from step (f) as predictive variables, and the nucleotide present at each genotyping position in each sequence in the training set as values for the predictive variables; and
(h) applying a statistical classification algorithm to the variable input matrix to generate a predictive algorithm, wherein the predictive algorithm specifies parameters for each genotyping position in the variable input matrix that when combined across the genotyping positions will discriminate among the genotypes represented in the training set; and
(i) validating the accuracy of the predictive algorithm generated in step (h); wherein steps (d) and (e) may be performed sequentially in either order or simultaneously.

2. The method of claim 1, wherein validating the predictive algorithm in step (i) comprises applying the algorithm to a testing set of at least two sequences of known genotypes and determining the accuracy of the algorithm in predicting the genotype of each testing sequence, wherein each testing sequence comprises the set of nucleotides at the genotyping positions identified in step (f).

3. The method of claim 1, wherein validating the predictive algorithm step (i) comprises:
dividing the training set of sequences into a training subset and a testing subset, wherein each subset sequence comprises the set of nucleotides at the genotyping positions identified in step (f) in claim 1, and wherein the sequences in the training subset are selected randomly from the training set to comprise a majority of the sequences associated with each genotype in the training set, and wherein the testing subset consists of the remainder of the training set sequences;
performing steps (g) and (h) in claim 1, with the proviso that the training set in each of steps (g) and (h) is replaced with the training subset;
determining the accuracy of the algorithm generated with the training subset in predicting the genotype of each sequence in the testing subset; and
repeating the dividing, performing and determining steps until an end condition is reached.

4. The method of claim 3, wherein the end condition is selected from the group consisting of: (i) a preset number of repetitions, (ii) the average classification error rate over the number of repetitions equals a preset value, and (iii) the operator chooses to stop.

5. The method of claim 3, wherein in each repetition the sequences in the training subset comprise 90% of the sequences associated with each genotype in the training set, and the end condition is reached after performing at least 10 repetitions.

6. The method of claims 2 or 3, wherein determining the accuracy of the predictive algorithm comprises calculating the sensitivity, specificity and overall accuracy using the following formulas:
$$sensitivity = \frac{TP}{TP + FN}$$
$$specificity = \frac{TN}{TN + FP}$$
$$overall accuracy = \frac{TP + TN}{TP + TN + FP + FN}$$
wherein TP, FP, TN and FN refer to the number of true positives, false positives, true negatives and false negatives, respectively, for the genotypes assigned by the predictive algorithm to the testing sequences.

7. The method of claim 1, wherein each of the genotypes in the training set obtained in step (a) has an estimated frequency of at least 10 in a population of subjects infected with the virus.

8. The method of claim 1, wherein the training set obtained in step (a) represents all know n genotypes of the virus which have an estimated frequency of at least 1% in a population of subjects infected with the virus.

9. The method of claim 7 or 8, wherein the population is selected from the group consisting of North America, the United States, South America, Europe, Western Europe, Eastern Europe, Asia, Japan, Africa and the world.

10. The method of claim 7, wherein the training set obtained in step (a) comprises at least 100, 200, 400 600, 800 or 1000 nucleotide sequences.

11. The method of claim 10, wherein the training set obtained in step (a) comprises at least 1000 nucleotide sequences.

12. The method of claim 10, wherein the majority of sequences in step (d) equals at least 70% or at least 80%.

13. The method of claim 12, wherein the training set obtained in step (a) comprises at least 1000 nucleotide sequences and represents all known genotypes of the virus which have an estimated frequency of at least 1% in a population of subjects infected with the virus and the majority of sequences in step (d) equals at least 80%.

14. The method of claim 1, wherein the statistical classification algorithm applied in step (h) is a support vector machine (SVM) algorithm, a random forest algorithm, a linear classifier algorithm, a k-nearest neighbor algorithm, a decision tree algorithm, a neural network algorithm, a Bayesian network algorithm.

15. The method of claim 14, wherein the statistical classification algorithm applied in step (h) is an SVM algorithm.

16. The method of claim 15, wherein the statistical classification algorithm applied in step (h) is a radial basis kernel of an SVM algorithm.

17. The method of claim 14, wherein the statistical classification algorithm applied in step (h) is a random forest algorithm.

18. The method of claim 1, wherein at least one of the aligned training sequences in step (b) is missing nucleotide data for at least one position in the template sequence and the method further comprises:
generating a position weight matrix (PWM) by determining, for each template position, the frequency that each of adenine (A), thymine (T), cytosine (C), and guanine (G) occur among the training set; and
assigning to each missing data position the most frequent nucleotide for that position from the PWM, wherein the PWM is generated after step (b) or step (c) but before step (d).

19. The method of claim 1, wherein the method further comprises analyzing the parameters specified in step (h) to identify any redundant positions in the initial set of genotyping positions.

20. The method of claim 19, wherein if at least one redundant genotyping position is identified, the method further comprises repeating steps (h) and (i) for n times and storing the result of the validating step, with the proviso that one redundant genotyping position is removed from the variable input matrix in the first repetition and one additional genotyping position is removed from the variable input matrix in each subsequent repetition, wherein n=the number of redundant genotyping positions.

21. The method of claim 1, wherein the virus is an RNA virus.

22. The method of claim 21, wherein the RNA virus is human immunodeficiency virus type 1 (HIV-1).

23. The method of claim 22, wherein the RNA virus is hepatitis C virus (HCV).

24. The method of claim 23, wherein the genome region comprises one or more of the 5′ noncoding region (NCR), the CORE region, the E1 region and the NS5B region.

25. The method of claim 23, wherein the genome region comprises one or both of the E1 region and the NS5B region.

26. The method of claim 23, wherein the genome region consists of the E1 region.

27. The method of claim 23, wherein the genome region consists of a sub-region of the NS5B.

28. The method of claim 27, wherein the sub-region consists of positions 8200-8600 of SEQ ID NO:1.

29. The method of claim 25, wherein obtaining the training set in step (a) comprises querying GenBank Release 149 for HCV-1 sequences and removing from the query results all redundant sequences belonging to the same isolates.

30. The method of claim 29, wherein the template sequence in step (b) is SEQ ID NO: 1.

31. A method of predicting the genotype of a virus present in a biological sample comprising:
identifying a set of genotyping positions;
assaying the viral nucleic acid in the sample to determine the nucleotide present at each genotyping position; and
inputting the assay results into a predictive algorithm; and
recording the genotype predicted by the algorithm, wherein the set of genotyping positions is identified and the predictive algorithm is generated according to a method comprising:
(a) obtaining, for at least one genomic region of the virus, a training set of nucleotide sequences of known genotypes, wherein the training set represents at least two different genotypes of the virus;
(b) aligning each sequence in the training set against a template sequence;
(c) storing the aligned sequences and their genotypes in a relational database, wherein each stored sequence is associated with its genotype;
(d) identifying, for each stored genotype, each position at which a majority of the sequences associated with that genotype have the same nucleotide;
(e) identifying each position that has the same nucleotide in each of the stored sequences;
(f) generating an initial set of genotyping positions for the virus by removing the positions identified in step (e) from the positions identified in step (d);
(g) compiling a variable input matrix which comprises the genotype for each sequence in the training set as a response variable, the genotyping positions from step (f) as predictive variables, and the nucleotide present at each genotyping position in each sequence in the training set as values for the predictive variables; and
(h) applying a statistical classification algorithm to the variable input matrix to generate a predictive algorithm, wherein the predictive algorithm specifies parameters for each genotyping position in the variable input matrix that when combined across the genotyping positions will discriminate among the genotypes represented in the training set; and
(i) validating the accuracy of the predictive algorithm generated in step (h);
wherein steps (d) and (e) may be performed sequentially in either order or simultaneously.

32. The method of claim 31, wherein the virus is hepatitis C virus (HCV).

33. The method of claim 32, wherein the set of genotyping positions comprises positions in one or both of the NS5B region and the E1 region.

34. The method of claim 33, wherein the template sequence used in step (b) is SEQ ID NO:1 and the set of genotyping positions comprises the NS5B genotyping positions in Table 1.

35. The method of claim 34, wherein assaying the viral nucleic acid in the sample comprises amplifying a target region containing the NS5B genotyping positions using a polymerase chain reaction (PCR) method.

36. The method of claim 34, wherein a set of amplification primers selected from the NS5B forward and reverse primers in Table 2 is used in the PCR method.

37. The method of claim 33, wherein the template sequence used in step (b) is SEQ ID NO:1 and the set of genotyping positions comprises the E1 genotyping positions in Table 1.

38. The method of claim 37, wherein assaying the viral nucleic acid in the sample comprises amplifying a target region containing the E1 genotyping positions using a polymerase chain reaction (PCR) method.

39. A computer readable medium comprising instruction code to cause a computer to execute the steps of a method for generating a genotype prediction algorithm for a virus, the method comprising:
(a) obtaining, for at least one genomic region of the virus, a training set of nucleotide sequences of known genotypes, wherein the training set represents at least two different genotypes of the virus;
(b) aligning each sequence in the training set against a template sequence;
(c) storing the aligned sequences and their genotypes in a relational database, wherein each stored sequence is associated with its genotype;
(d) identifying, for each stored genotype, each position at which a majority of the sequences associated with that genotype have the same nucleotide;
(e) identifying each position that has the same nucleotide in each of the stored sequences;
(f) generating an initial set of genotyping positions for the virus by removing the positions identified in step (e) from the positions identified in step (d);
(g) compiling a variable input matrix which comprises the genotype for each sequence in the training set as a response variable, the genotyping positions from step (f) as predictive variables, and the nucleotide present at each genotyping position in each sequence in the training set as values for the predictive variables; and
(h) applying a statistical classification algorithm to the variable input matrix to generate a predictive algorithm, wherein the predictive algorithm specifies parameters for each genotyping position in the variable input matrix that when combined across the genotyping positions will discriminate among the genotypes represented in the training set; and
(i) validating the accuracy of the predictive algorithm generated in step (h); wherein steps (d) and (e) may be performed sequentially in either order or simultaneously.

40. The computer readable medium of claim 39, wherein the template sequence used in step (b) is SEQ ID NO:1.

41. A processor programmed to execute the steps of a method for generating a genotype prediction algorithm for a virus, the method comprising:
(a) obtaining, for at least one genomic region of the virus, a training set of nucleotide sequences of known genotypes, wherein the training set represents at least two different genotypes of the virus;
(b) aligning each sequence in the training set against a template sequence;
(c) storing the aligned sequences and their genotypes in a relational database, wherein each stored sequence is associated with its genotype;
(d) identifying, for each stored genotype, each position at which a majority of the sequences associated with that genotype have the same nucleotide;
(e) identifying each position that has the same nucleotide in each of the stored sequences;
(f) generating an initial set of genotyping positions for the virus by removing the positions identified in step (e) from the positions identified in step (d);
(g) compiling a variable input matrix which comprises the genotype for each sequence in the training set as a response variable, the genotyping positions from step (f) as predictive variables, and the nucleotide present at each genotyping position in each sequence in the training set as values for the predictive variables; and
(h) applying a statistical classification algorithm to the variable input matrix to generate a predictive algorithm, wherein the predictive algorithm specifies parameters for each genotyping position in the variable input matrix that when combined across the genotyping positions will discriminate among the genotypes represented in the training set; and
(i) validating the accuracy of the predictive algorithm generated in step (h); wherein steps (d) and (e) may be performed sequentially in either order or simultaneously.

42. The processor of claim 41, wherein the template sequence used in step (b) is SEQ ID NO:1.

43. A computer system for predicting the genotype of a virus present in a biological sample, the computer system comprising: a relational database for storing sequences of the virus associated with their genotypes, a processor connected to the database, and a computer program, for controlling the processor, wherein the computer program comprises instruction code to perform the steps of a method for generating a genotype prediction algorithm for a virus, the method comprising:
(a) obtaining, for at least one genomic region of the virus, a training set of nucleotide sequences of known genotypes, wherein the training set represents at least two different genotypes of the virus;
(b) aligning each sequence in the training set against a template sequence;
(c) storing the aligned sequences and their genotypes in a relational database, wherein each stored sequence is associated with its genotype;
(d) identifying, for each stored genotype, each position at which a majority of the sequences associated with that genotype have the same nucleotide;
(e) identifying each position that has the same nucleotide in each of the stored sequences;
(f) generating an initial set of genotyping positions for the virus by removing the positions identified in step (e) from the positions identified in step (d);
(g) compiling a variable input matrix which comprises the genotype for each sequence in the training set as a response variable, the genotyping positions from step (f) as predictive variables, and the nucleotide present at each genotyping position in each sequence in the training set as values for the predictive variables; and
(h) applying a statistical classification algorithm to the variable input matrix to generate a predictive algorithm, wherein the predictive algorithm specifies parameters for each genotyping position in the variable input matrix that when combined across the genotyping positions will discriminate among the genotypes represented in the training set; and
(i) validating the accuracy of the predictive algorithm generated in step (h); wherein steps (d) and (e) may be performed sequentially in either order or simultaneously.

44. A kit for genotyping a hepatitis C virus in a sample, comprising a computer readable medium comprising:
instruction code to cause a computer to execute the steps of a method for generating a genotype prediction algorithm for the virus;
at least one NS5B forward amplification primer selected from the NS5B forward primers in Table 2; and
at least one NS5B reverse amplification primer selected from the NS5B reverse primers in Table 2;
wherein the method comprises (a) obtaining, for at least one genomic region of the virus, a training set of nucleotide sequences of known genotypes, wherein the training set represents at least two different genotypes of the virus;
(b) aligning each sequence in the training set against a template sequence, wherein the template sequence is SEQ ID NO:1;
(c) storing the aligned sequences and their genotypes in a relational database, wherein each stored sequence is associated with its genotype;
(d) identifying, for each stored genotype, each position at which a majority of the sequences associated with that genotype have the same nucleotide;
(e) identifying each position that has the same nucleotide in each of the stored sequences;
(f) generating an initial set of genotyping positions for the virus by removing the positions identified in step (e) from the positions identified in step (d);
(g) compiling a variable input matrix which comprises the genotype for each sequence in the training set as a response variable, the genotyping positions from step (f) as predictive variables, and the nucleotide present at each genotyping position in each sequence in the training set as values for the predictive variables; and
(h) applying a statistical classification algorithm to the variable input matrix to generate a predictive algorithm, wherein the predictive algorithm specifies parameters for each genotyping position in the variable input matrix that when combined across the genotyping positions will discriminate among the genotypes represented in the training set; and
(i) validating the accuracy of the predictive algorithm generated in step (h); wherein steps (d) and (e) may be performed sequentially in either order or simultaneously.

45. The kit of claim 44, which further comprises at least one E1 forward amplification primer selected from the E1 forward primers in Table 2 and at least one E1 reverse amplification primer selected from the E1 reverse primers in Table 2.
